(19) United States
(12) Patent Application Publication
(10) Pub. No.: US 2002/0186917 A1
(43) Pub. Date: Dec. 12, 2002

(54) Method and apparatus for accurately aligning a tiltable mirror employed in an optical switch

(76) Inventor: John Kalinowski, Flemington, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/879,847

(22) Filed: Jun. 12, 2001

(51) Int. Cl. G02B 6/35; G02B 6/293; H04J 14/02

(52) U.S. Cl. 385/18; 385/24; 359/128

(57) ABSTRACT

An optical switch for use in a WDM communication system is provided which includes a tiltable mirror assembly having a mirror and an actuator for orienting the mirror. At least one receiver is also provided for receiving an optical beam reflected from the tiltable mirror. A controller, which drives the actuator, includes an alignment mechanism having a common mode rejection arrangement, responsive to a signal received from the receiver, for adjusting the actuator to orient the tiltable mirror so that an optical beam reflected therefrom is coupled to the receiver with a particular efficiency.

### FIELD OF THE INVENTION

The invention relates generally to an optical communications system and more particularly to a mechanism for aligning the optical elements in an optical switch that flexibly routes light in a wavelength-selective manner.

### BACKGROUND OF THE INVENTION

The number of applications in which micromirrors are employed has been growing rapidly in recent years. In particular, micromirrors have many uses related to optical switching including, beam steering, shaping and scanning or projection applications, as well as for use in optical communication systems. For example, in wavelength division multiplexed communication systems, optical switches allow different wavelength channels to be directed along different paths in the network. Optical switches may be fixed wavelength-dependent elements in which a given wavelength is always routed along a given path. More flexible optical switches are reconfigurable elements that can dynamically change the path along which a given wavelength is routed. An example of a flexible, reconfigurable optical switch is disclosed in U.S. Application Ser. No. [PH01-00-02], which is hereby incorporated by reference in its entirety.

The growing use of micromirrors in optical communications systems has largely arisen because of advances in MEMS (microelectromechanical systems) technology. MEMS refers to systems that combine electrical and mechanical components, including optical components, into a package that is physically very small. These systems are generally fabricated using integrated circuit fabrication techniques or similar techniques such as surface micromachining or bulk micromachining. Various sensors and actuators can be built including engines, transmissions, transducers, resonators, and mirrors that are measured in terms of microns. The degree of complexity depends on the number of movable levels or planes that the fabrication technique provides. In a MEMS micromirror, the mirror is supported by one or more MEMS flexure arms. Actuation of the flexure arms tilts the mirror surface to alter the direction of propagation of an incident beam of light. Examples of such micro-electromechanical mirrors are disclosed in U.S. Pat. No. 6,028,689 and the references cited therein.

FIG. 1 shows the pertinent elements of a simplified optical switch that employs a MEMS mirror. The switch 102 includes mirror 102 and receivers 110₁ 110₂, 110₃. . . 110ₙ. Mirror 102 reflects an incoming optical beam 105 toward a designated one of the optical receivers 110₁, 110₂, 110₃. . . 110ₙ . The mirror 102 pivots along one axis to direct optical beam 105 toward any receiver or group of adjacent receivers. The receivers could be photodetectors such as photodiodes for converting the incoming light into an electrical signal. Alternatively, as represented by reference numeral 110₁, the receiver may employ a fiber optic conductor for routing the incoming light to another location. While extremely simple, the configuration in FIG. 1 serves as an optical switch because it makes optical connections between a source and destination location.

As the orientation of mirror 102 is adjusted so that reflected light is directed to a selected one of the receivers, the alignment between the mirror 102 and the selected receiver should be sufficiently accurate to ensure a maximum coupling efficiency of light from the mirror to the receiver. One way to accomplish this alignment is by dead reckoning. Unfortunately, dead reckoning can lead to poor pointing accuracy and thus low coupling efficiency. Inaccuracies in the mirror's position can be caused by nonlinearities in the mirror steering apparatus, shifts in the locations of various mechanical parts arising from temperature variations, manufacturing or assembly tolerances, aging of electronic components employed in the mirror control circuitry and the like.

FIG. 2 shows a plan view of a receiver face 200, which in this example is a square photodetector. An optical beam 210 is directed onto the photodetector. As shown, only a portion of the beam 210 is incident on the receiver and thus a portion of the light is not detected. As a result, some of the signal is lost and coupling efficiency is poor. One way to optimize the coupling efficiency after a coarse alignment has been made between the mirror and receiver is to monitor the received signal while tilting the mirror by small increments. After each incremental change in the mirror's position, the signal level is measured and compared to the signal level before the mirror's position was changed. An increase in the signal level indicates that the alignment is improving, suggesting that the mirror's position should continue to be incrementally adjusted in the same direction. Conversely, a decrease in signal level indicates that the mirror and receiver are increasingly misaligned, suggesting that the mirror's position should be incrementally adjusted in the opposite direction. If the signal undergoes little or no change as the mirror's position is incrementally adjusted, the alignment is optimal and no further adjustment is needed.

FIG. 3 illustrates the aforementioned approach for an idealized light beam having a circular shape and a uniform and constant intensity throughout its diameter. The receiver on which the light is incident is also assumed to be ideal, producing an electrical signal that is proportional to the power striking its surface and having a uniform photoresponse across its surface. That is, a given optical beam falling entirely within the active area of the receiver, regardless of its precise location, results in a constant electrical signal. As the optical beam begins to sweep the receiver surface from left to right, the beam is initially completely misaligned with the receiver so that initially no electrical signal is produced. As the beam enters the active area of the receiver a small electrical signal evolves. The signal increases as a larger portion of the beam intersects the active area of the receiver. Once the beam is wholly contained within the receiver's active area the signal levels off at its maximum value and remains constant until the beams begins to exit the active area of receiver at its right-most edge. As the graph shows, the signal level drops to zero when the beam completely exits the active area of the receiver.

Unfortunately, in practice, the idealized situation presented in connection with FIG. 3 is unlikely to arise. More typically, the beam will have an irregular shape and/or there will be nonuniformities in intensity across the beam's surface. Instead of the idealized signal response shown in FIG. 3, a more realistic signal response is shown in FIG. 4. As shown, the signal response includes local minimums that are caused by the irregularities and nonuniformities. The local minimums effectively serve as traps, satisfying the optimal alignment condition that a maximum in the coupling efficiency has been achieved when in fact it has not. As a result, the electronics controlling the position of the mirror could be misled, moving the mirror in the wrong direction in an attempt to maximize the coupling efficiency or prematurely terminating the alignment process before the maximum coupling efficiency has been achieved.

Accordingly, it would be desirable to provide an optical switch having a tiltable mirror that can be easily and accurately aligned with the receivers in the switch so that an optimal coupling efficiency can be achieved.

### SUMMARY OF THE INVENTION

In accordance with the present invention, an optical switch for use in a WDM communication system is provided that includes a tiltable mirror assembly having a mirror and an actuator for orienting the mirror. At least one receiver is also provided for receiving an optical beam reflected from the tiltable mirror. A controller, which drives the actuator, includes an alignment mechanism having a common mode rejection arrangement, responsive to a signal received from the receiver, for adjusting the actuator to orient the tiltable mirror so that an optical beam reflected therefrom is coupled to the receiver with a particular efficiency.

In accordance with one aspect of the invention, the common mode rejection arrangement is a synchronous detector.

In accordance with another aspect of the invention, the common mode rejection arrangement is a two-phase lock-in amplifier.

In accordance with yet another aspect of the invention, the synchronous detector includes a modulator generating a reference signal for dithering the mirror orientation about a static position. The reference signal may be a fixed frequency signal or, alternatively, it may have a frequency with a psuedo-random sequence.

In accordance with another aspect of the invention, the particular coupling efficiency that is achieved is a maximized coupling efficiency.

In accordance with another aspect of the invention, the tiltable mirror assembly includes a MEMs mirror.

In accordance with another aspect of the invention, the optical beam comprises a WDM optical signal.

In accordance with yet another aspect of the invention, the synchronous detector includes a switch having inverting and noninverting inputs each receiving a signal from the receiver. The synchronous detector also includes a modulator for generating a reference signal dithering the mirror orientation about a static position and driving the switch between the inverting and noninverting inputs.

In accordance with yet another aspect of the invention, a method is provided for orienting a tiltable mirror so that an optical beam reflected therefrom is directed to a selected receiver with a particular coupling efficiency. The method begins by varying an orientation of the mirror about a static position at a prescribed frequency. Next, a signal is received that represents an amount of optical energy incident on the selected receiver. The received signal is rectified at the prescribed frequency to generate an error signal. Finally, the static position of the mirror is adjusted based on the error signal.

In accordance with another aspect of the invention, an optical switch is provided which has an optical arrangement. The optical arrangement includes a plurality of input/output ports for receiving one or more wavelength components from among a plurality of components of a WDM optical signal, and a plurality of wavelength selective elements each selecting a wavelength component from among the plurality of wavelength components. The optical arrangement also includes a plurality of optical elements each associated with one of the wavelength selective elements. Each of the optical elements direct the selected wavelength component selected by the associated selective element to a given one of the plurality of input/output ports independently of every other wavelength component. The given input/output port may be variably selectable from among any of the plurality of input/output ports. The optical switch further includes at least one receiver for receiving the selected wavelength components and a plurality of controllers each associated with and driving one of the optical elements. Each of the controllers include an alignment mechanism, responsive to a signal received from the receiver, for orienting the optical element so that the selected wavelength directed by the optical element is coupled to the receiver with a particular efficiency.

### BRIEF DESCRIPTION OF THE DRAWINGS

FIG. 1 shows the pertinent elements of a simplified optical switch that employs a MEMS mirror.

FIG. 2 shows a plan view of a receiver face such as a photodetector on which an optical beam is directed.

FIG. 3 illustrates an idealized response provided by a receiver as an optical beam traverses its photosensitive surface.

FIG. 4 illustrates an exemplary realistic response provided by a receiver as an optical beam traverses its photosensitive surface.

FIG. 5 shows an exemplary optical switch in which the present invention may be employed.

FIG. 6 shows an arrangement for illustrating the basic operational principles of a synchronous detector.

FIG. 7 shows a synchronous detector that may be employed in the present invention to align an optical beam reflected from a tiltable mirror onto a receiver.

FIG. 8 is a graph of the value of the output signal from an optical detector with respect to the mirror position as the mirror position is dithered by a reference signal.

FIG. 9 shows a phase insensitive detector arrangement, which may be employed in the present invention.

FIG. 10 shows an exemplary controller incorporating a synchronous detector, which may be used to drive the mirror actuator of a tiltable mirror assembly.

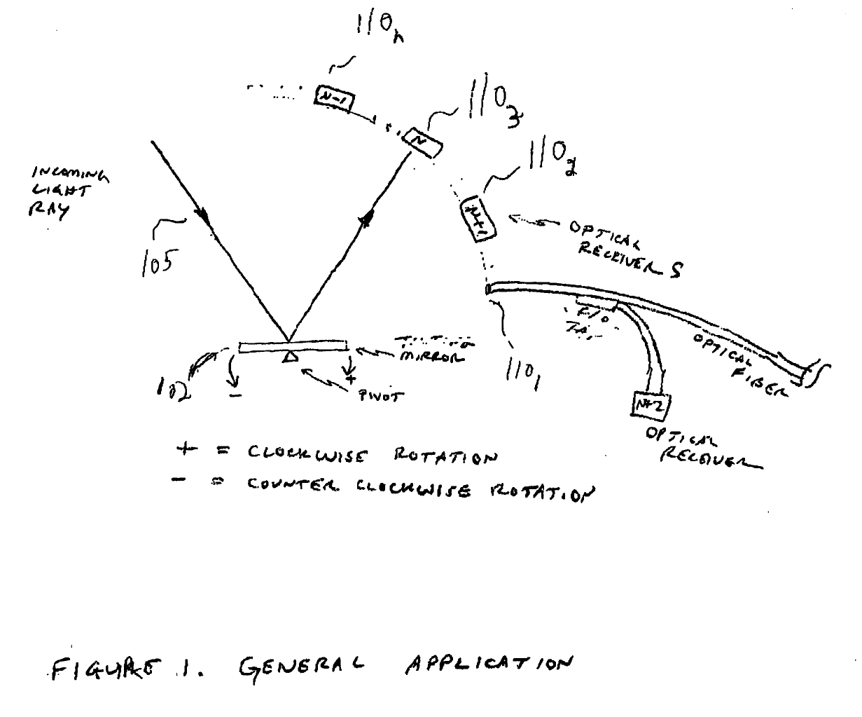

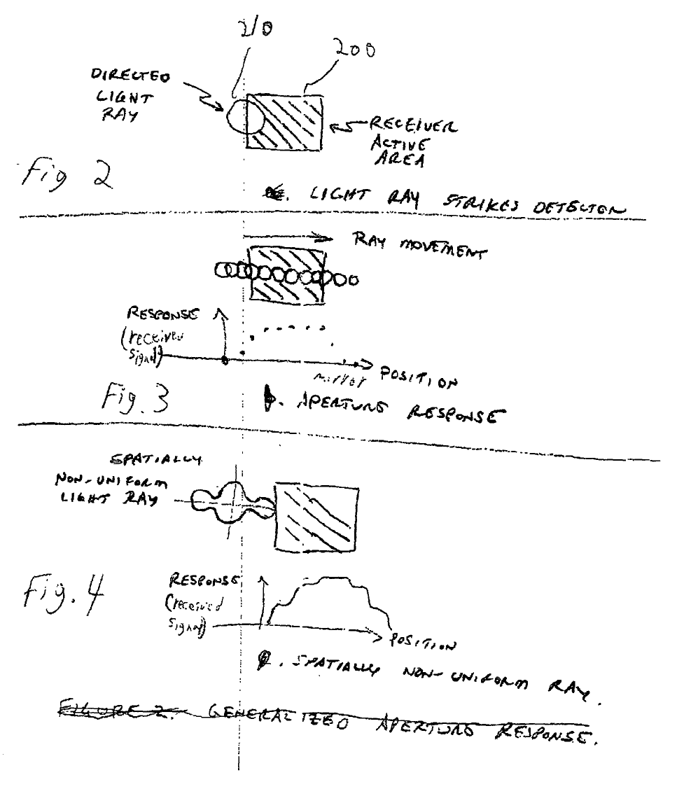

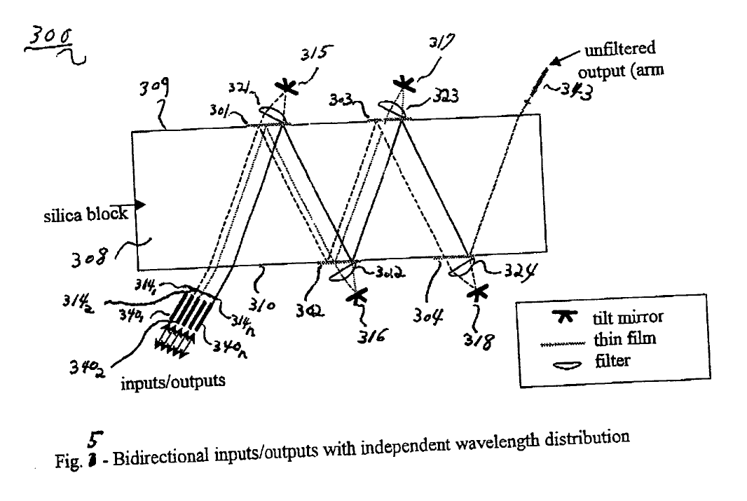

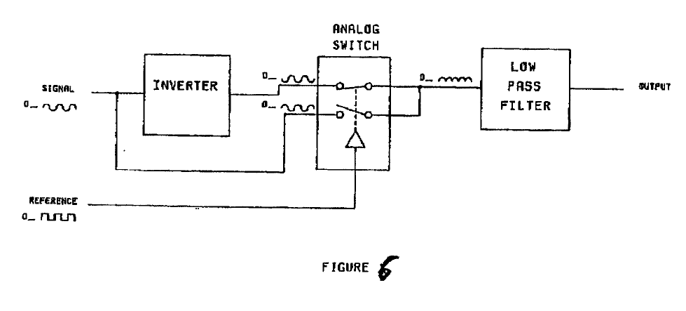

### DETAILED DESCRIPTION

The present invention provides a method and apparatus for optimally aligning a tiltable mirror such as a micromirror so that a reflected beam of light is directed onto a desired target. In a preferred embodiment of the invention the tiltable mirror is employed in an optical switch such as disclosed in Ford et al., Postdeadline papers LEOS ’97, IEEE Lasers and Electro-Optics Society, for example.

For purposes of illustration only the present invention will be depicted in connection with the optical switch disclosed in the aforementioned U.S. Appl. Serial No. [PH01-00-02], which is shown in FIG. 5. Of course, those of ordinary skill in the art will recognize that the invention is equally applicable to any optical switch employing a tiltable mirror. In FIG. 5, the optical switch 300 comprises an optically transparent substrate 308, a plurality of dielectric thin film filters 301, 302, 303, and 304, a plurality of collimating lens pairs 321ₗ, and 321₂, 322₁, and 322₂, 323₁ and 323₂, 324₁,and 324₂, a plurality of tiltable mirrors 315, 316, 317, and 318 and a plurality of output ports 340₁, 340₂, . . . 340ₙ. A first filter array is composed of thin film filters 301 and 303 and a second filter array is composed of thin film filters 302 and 304. Individual ones of the collimating lens pairs 321-324 and tiltable mirrors 315-318 are associated with each of the thin film filters. Each thin film filter, along with its associated collimating lens pair and tiltable mirror effectively forms a narrow band, free space switch, i.e. a switch that routes individual wavelength components along different paths. The tiltable mirrors are micromirrors such as the previously mentioned MEMS mirrors. Alternatively, other mechanisms may be employed to control the position of the mirrors, such as piezoelectric actuators, for example.

In operation, a WDM optical signal composed of different wavelengths λ₁, λ₂, λ₃ and λ₄ is directed from the optical input port 312 to a collimator lens 314. The WDM signal traverses substrate 308 and is received by thin film filter 301. According to the characteristics of the thin film filter 301, the optical component with wavelength λ₁ is transmitted through the thin film filter 301, while the other wavelength components are reflected and directed to thin film filter 302 via substrate 308. The wavelength component λ₁, which is transmitted through the thin film filter 301, is converged by the collimating lens 321₁ onto the tiltable mirror 315. Tiltable mirror 315 is positioned so that wavelength component λ₁, is reflected from the mirror to a selected one of the output ports 340₁-340ₙ, via thin film filters 302-304, which all reflect wavelength component ′₁. The particular output port that is selected to receive the wavelength component will determine the particular orientation of the mirror 315.

As mentioned, the remaining wavelength components λ₂, λ₃, and λ₄ are reflected by thin film filter 301 through lens 321₂ back into substrate 308 and directed to thin film filter 302. Wavelength component λ₂ is transmitted through thin film filter 302 and lens 322₁, and directed to a selected output port by tiltable mirror 316 via thin film filters 303-304, which all reflect wavelength component λ₂. Similarly, all other wavelength components are separated in sequence by the thin film filters 303-304 and subsequently directed by tiltable mirrors 317-318 to selected output ports. By appropriate actuation of the tiltable mirrors, each wavelength component can be directed to an output port that is selected independently of all other wavelength components.

As previously mentioned, it is important to ensure proper alignment among the mirrors and the output ports of the optical switch to minimize optical losses. Accordingly, the control circuitry associated with each of the tiltable mirrors should incorporate a feedback arrangement to ensure proper alignment. In the present invention, the feedback arrangement that is employed is a common mode rejection arrangement such as a synchronous detector.

A synchronous detector, also known as a coherent detector, phase detector, or balanced demodulator, provides a means for detecting synchronous signals in the presence of noise and other interfering signals. The term “synchronous signal” refers to a signal that is synchronous with a reference frequency. The present invention employs a synchronous detector to eliminate noise arising from temporal variations of the beam so that intensity fluctuations arising only from variations in the alignment between the mirror and the receiver can be measured. As detailed below, in the context of the present invention, the reference frequency is a dithering signal that modulates the control signal driving the tiltable mirror. The synchronous signal is the output signal from the detector that receives the optical beam from the mirror.

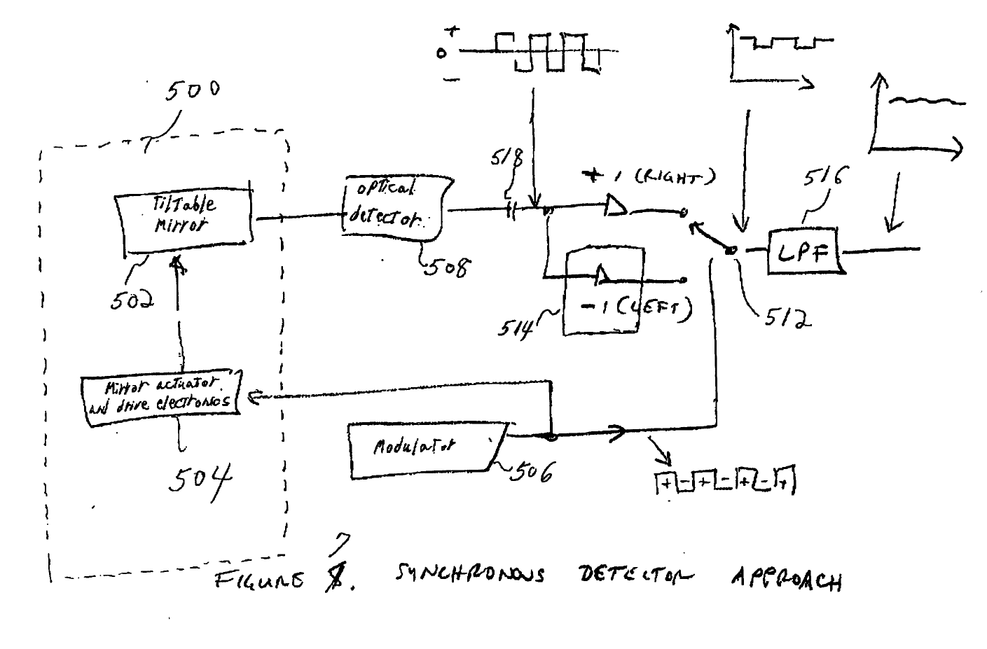

Synchronous detectors may be implemented in many different ways. The basic operational principles of such a detector will be illustrated in connection with the arrangement shown in FIG. 6. An input signal is fed to an inverting amplifier with a gain of one. The signal and its inverse are switched by an analog switch driven by a reference signal. The reference signal has the same frequency and phase as the input signal. The analog switch is such that when the reference signal is low the inverse is connected to the input of the low-pass filter and when the reference signal is high the signal is connected directly to the input of the lowpass filter. The resulting waveform is shown in FIG. 6 at the output of the switch. For these conditions, the waveform resembles a fullwave rectified waveform. The output waveform from the switch arises because the input signal and reference signal have the same frequency and phase. The output signal is passed through a low pass filter. The low-pass filter removes the AC components of the waveform giving the average value as a DC voltage at the output.

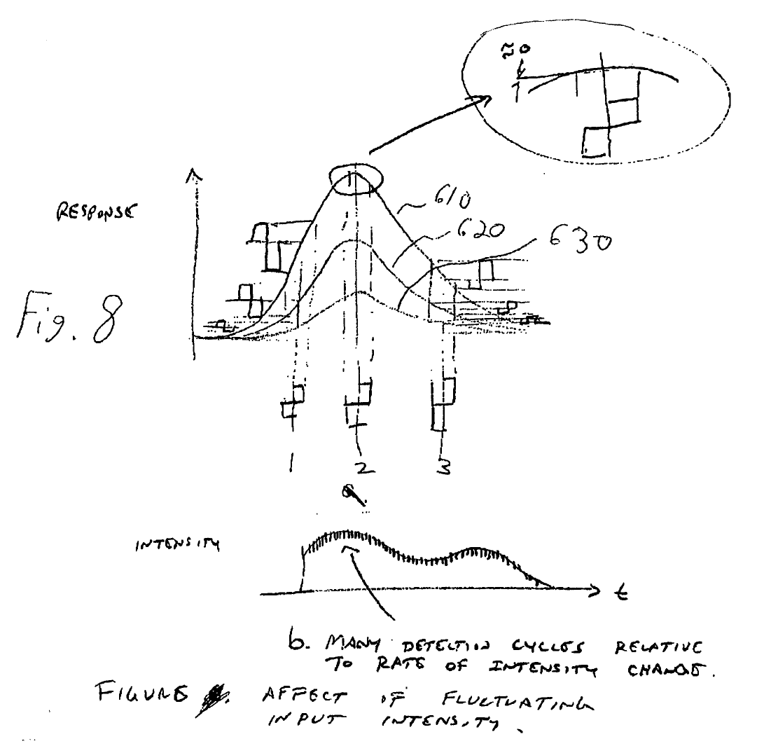

FIG. 7 shows a synchronous detector as applied to a tiltable mirror 500 that includes a mirror 502 whose orientation is controlled by actuator 504. The orientation of mirror 502 is to be adjusted so that it reflects an optical beam to optical detector 508, which generates an electrical signal in response to the optical beam. Tiltable mirror 500 and optical detector 508 may be part of an optical switch, such as the optical switch shown in FIG. 5. The synchronous detector includes a modulator 506, inverter 514, switch 512, and low pass filter 516. Modulator 506 generates a reference or dithering signal that is applied to both the mirror actuator 504 and switch 512. The orientation of mirror 502 is dithered in response to the reference signal so that the alignment between the mirror 502 and optical detector 508 is varied. Optical detector 508 generates an electrical output signal that varies in accordance with the amount of light it receives from the mirror 502. The output signal is capacitively coupled to the synchronous detector by capacitor 518. As in FIG. 6, the output signal is split and a portion directed to inverter 514 so that inverting and non-inverting signals are generated and applied to switch 512. Because switch 512 is driven by modulator 506, switch 512 effectively rectifies the electrical output signal. The low pass filter 516 averages the rectified signal to yield a DC voltage that is proportional to the strength of the received signal.

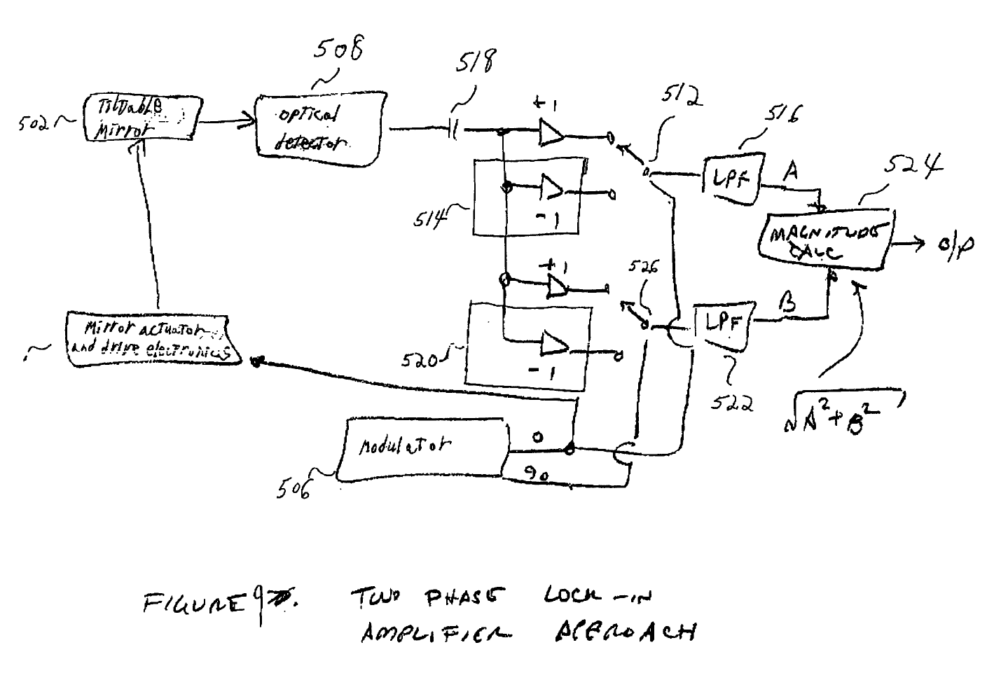

The manner in which the synchronous detector shown in FIG. 7 is employed to properly align the mirror 502 with the optical detector 508 will be explained in connection with FIG. 8. FIG. 8 graphically displays the value of the output signal from the optical detector 508 with respect to the mirror position as the mirror position is dithered by the reference signal from modulator 506. Each curve represents a different time at which the optical signal is measured. That is, curves 610, 620 and 630 may have been generated at times t₁, t₂, and t₃, respectively. The output signal from the optical detector 508 varies among the three curves because of system fluctuations arising from intensity variations. That is, in an ideal situation in which there were no such system fluctuations the three curves would be coincident with one another.

To facilitate an understanding of the invention, first assume the mirror is dithered about position 1 in FIG. 8. The reference signal from the modulator is assumed to first drive the mirror so that the optical beam moves to the right in FIG. 8 (on a positive reference signal) and then to the left (on a negative reference signal). As the beam moves to the right, the output signal from the detector 508 increases because the alignment between the mirror and the optical detector improves. Conversely, when the mirror is driven so that the beam moves to the left the output signal from the optical detector 508 decreases. Referring again to FIG. 7, the output signal is AC coupled to the synchronous detector so that any DC offsets are rejected. When the mirror is driven so that the beam moves to the right, the output signal arriving at the inverter 514 is positive so that when the signal arrives at low pass filter 512 it is in phase with the reference signal arriving at switch 512. Accordingly, the output from the low pass filter 512 is positive. Likewise, when the mirror is driven so that the beam moves to the left, a negative output signal arrives at inverter 514 while the reference signal causes the switch 512 to select the inverting path. Accordingly, the output from the low pass filter 516 is positive. In summary, when the mirror orientation is dithered about position 1 in FIG. 6, the output from the synchronous detector will be positive.

Next, assume the mirror 502 is dithered about position 2 in FIG. 8, which corresponds to the maximum coupling efficiency between the mirror 502 and the optical detector 508. As the mirror orientation is changed so that the beam moves left and right across the optical detector 508, the output signal generated by the optical detector 508 is constant or nearly constant so that the signal arriving at the inverter 514 is zero or near zero. As a result the output from the synchronous detector will be zero or nearly zero, regardless of whether the mirror 502 is dithered to the right or the left.

Finally, assume the mirror 502 is dithered about position 3 in FIG. 8. This situation is the converse of the situation arising when the mirror is dithered about position 1. That is, when the mirror is driven so that the beam moves to the right, the output signal arriving at the inverter 514 is negative so that the signal arriving at low pass filter 512 is out of phase with the reference signal arriving at switch 512. Accordingly, the output from the low pass filter 512 is negative. Likewise, when the mirror is driven so that the beam moves to the left, a positive output signal arrives at inverter 514 while the reference signal causes the switch 512 to select the inverting path. Accordingly, the output from the low pass filter 516 is again negative. In summary, when the mirror orientation is dithered about position 3 in FIG. 8, the output from the synchronous detector will be negative.

Based on the above analysis, it can be seen that the synchronous detector in effect measures the slope of the curves in FIG. 8. Accordingly, for a given mirror position, the output from the synchronous detector is the same regardless of system fluctuations that cause the signal response to vary with time. The output from the synchronous detector can be used by the controller that determines the mirror position to properly align the mirror. In the example shown in FIG. 8, a positive output from the synchronous detector would cause the controller to adjust the mirror so that the reflected beam moves toward the right, while a negative output from the synchronous detector would cause the controller to adjust the mirror so that the reflected beam moves toward the left. The mirror would be aligned when the synchronous detector output is zero, indicating that the controller has determined the proper orientation of the mirror that maximizes the coupling efficiency.

In general, a communication system will employ many optical switches throughout the network. If such switches incorporate tiltable mirrors with a common mode rejection alignment mechanism of the type disclosed herein, interference may occur that adversely effects the performance of the alignment mechanism. In particular, if all the synchronous detectors employed in the various switches use the same reference frequency, activity from one switch can interfere over the network with the activity of another switch. This interference could cascade from one switch to another in a serial manner. To overcome this problem, in some embodiments of the invention the alignment mechanisms in each switch in the network operate at a different reference frequency. While this approach overcomes the problems of interference, in many cases it may be impractical because it requires the switch manufacturer to supply many different switches having the same performance characteristics. Moreover, whenever a network operator needs to add an additional switch or switches to an existing network this approach requires the network operator to make sure that it selects switches that operate at different reference frequencies from all the other switches currently in the network. Accordingly, it would be preferable if all switches with a given set of performance characteristics were interchangeable.

To overcome this problem, in some embodiments of the invention the reference frequency that is employed by the alignment mechanism is a psuedorandom sequence that preferably maintains a 50% duty cycle. The modulator in each switch generates its own psuedo-random sequence. By frequency hopping on a cycle-by-cycle basis, interference among switches is minimized. Any interference that does occur among switches in the same network would be short lived, occurring only for a single cycle and rarely with a matching phase. Accordingly, many identical switches can be used in the same network.

Those of ordinary skill in the art will recognize that the present invention encompasses other forms of modulation in addition to a fixed frequency with a 50% duty cycle and a psuedo-random sequence. For example, a chirped frequency may be employed.

The synchronous detector shown in FIG. 7 assumes that the reference frequency is in phase with the output signal from the optical detector. In many cases however, this phase relationship will not be maintained. One source of this problem arises because of the increased torsion in the mechanical supports employed in the mirror, which arises as the angle at which the mirror is oriented increases. As a result the response of the mirror will tend to lag behind the drive signal applied to it. Unfortunately, as the phase relationship between the output signal and the reference frequency diminishes, the synchronous detector may begin to supply erroneous results.

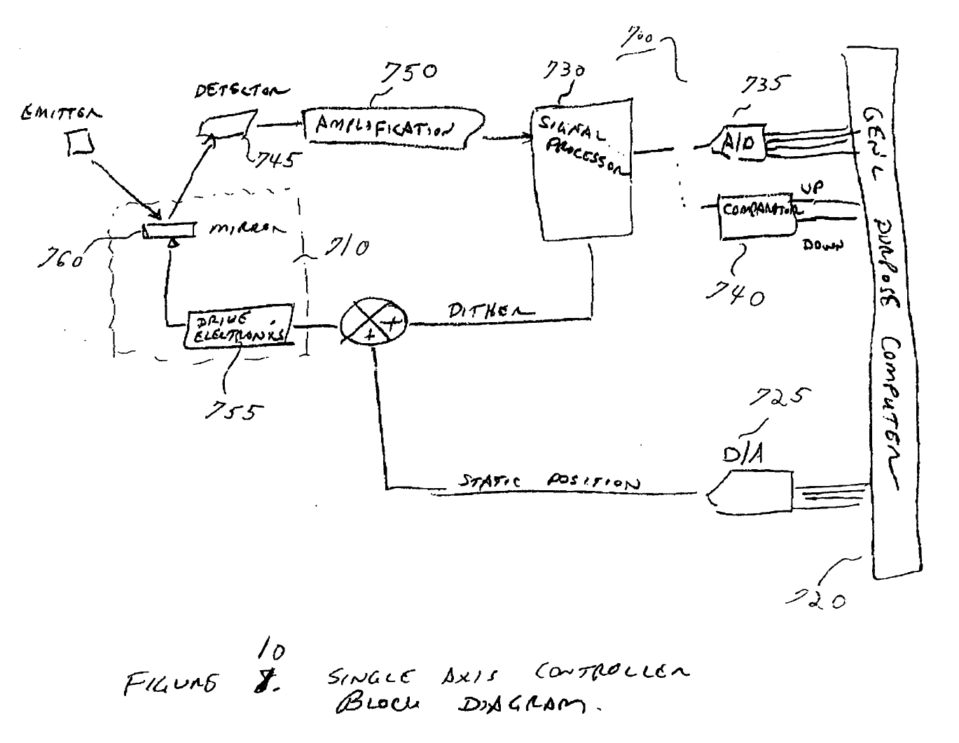

FIG. 9 shows a common mode rejection arrangement that does not require the output signal from the optical detector and the reference signal generated by the synchronous detector to be in phase with one another. This arrangement employs a technique based on a two-phase lock in amplifier. The arrangement in FIG. 9 is similar to the detector shown in FIG. 7 except that in FIG. 9 an additional switch 526 or mixer is employed. In FIGS. 7 and 9, like reference numerals refer to like elements. Switches 512 and 526 are driven in quadrature, i.e., 90° out of phase, by the modulator 506. In operation, the output signal from the optical detector 508 is split so that a portion of it is directed to inverting and noninverting inputs of switch 512 and another portion is directed to inverting and noninverting inputs of switch 526. The signals from switches 512 and 526 are directed to low pass filter 516 and 522, respectively, which operate in the same manner discussed in connection with FIG. 5. The outputs from the two filters 516 and 522 are vectorally summed by magnitude calculator 524 to generate an output value that can be used by the controller determining the mirror's orientation in the same manner as the output signal discussed in connection with FIG. 7. A primary advantage of the output signal generated by the arrangement in FIG. 9 over the synchronous detector in FIG. 7 is that it is insensitive to the phase between the reference signal and the output from the optical detector.

As with the embodiment of the invention in FIG. 7, the embodiment of the invention shown in FIG. 9 may employ a fixed reference frequency, a psuedo-random reference signal, or a signal that is modulated in any other appropriate manner.

FIG. 10 shows one example of a controller 700 that may be employed to drive the mirror actuator 755 of mirror assembly 710. Controller 700 includes a processor 720, a D/A converter 725 for providing a static signal from the processor 720 for establishing a coarse adjustment of the mirror 760 at a static position, a feedback arrangement 730 that provides a dither signal which is summed with the static signal to dither the orientation of the mirror 760 about its coarsely adjusted orientation. As described above, the feedback arrangement 730 may be a synchronous detector or a two-phase lock-in amplifier that receives the output signal from the optical detector 745 via amplifier 750. The analog output from the feedback arrangement 730 is provided to processor 720 via an A/D converter 735 or a window comparator 740. If the A/D converter 735 is employed, the digital signal received by the processor 720 indicates the slope and polarity of the output from the synchronous detector. If the window comparator 740 is employed, it is arranged so that it generates a signal having three states: move left, move right, or remain fixed. In response to the signal received from the A/D converter 735 or the window comparator 740, the processor 720 provides a new static signal to adjust the static position of the mirror to improve the coupling efficiency between the mirror 760 and the detector 745.

Although various embodiments are specifically illustrated and described herein, it will be appreciated that modifications and variations of the present invention are covered by the above teachings and are within the purview of the appended claims without departing from the spirit and intended scope of the invention. For example, while the controller and alignment mechanism has been illustrated in connection with a tiltable mirror whose position can be adjusted about a single axis, one of ordinary skill in the art will recognize that the invention can be readily extended to adjust a tiltable mirror about two different axes.

1. In a WDM communication system, an optical switch, comprising:
a tiltable mirror assembly having a mirror and an actuator for orienting the mirror;
at least one receiver for receiving an optical beam reflected from the tiltable mirror;
a controller for driving the actuator, said controller including an alignment mechanism having a common mode rejection arrangement, responsive to a signal received from the receiver, for adjusting the actuator to orient the tiltable mirror so that an optical beam reflected therefrom is coupled to the receiver with a particular efficiency.

2. The optical switch of claim 1 wherein said common mode rejection arrangement is a synchronous detector.

3. The optical switch of claim 1 wherein said common mode rejection arrangement is a two-phase lock-in amplifier.

4. The optical switch of claim 2 wherein said synchronous detector includes a modulator for generating a reference signal for dithering the mirror orientation about a static position.

5. The optical switch of claim 4 wherein said reference signal is a fixed frequency signal.

6. The optical switch of claim 4 wherein said reference signal has a frequency with a psuedo-random sequence.

7. The optical switch of claim 1 wherein said particular efficiency is a maximized coupling efficiency.

8. The optical switch of claim 1 wherein said tiltable mirror assembly includes a MEMs mirror.

9. The optical switch of claim 1 wherein said optical beam comprises a WDM optical signal.

10. The optical switch of claim 2 wherein said synchronous detector comprises:
a switch having inverting and noninverting inputs each receiving a signal from the receiver; and
a modulator for generating a reference signal for dithering the mirror orientation about a static position and for driving said switch between the inverting and noninverting inputs.

11. The optical switch of claim 10 wherein said controller further includes a processor receiving a second signal from the switch.

12. The optical switch of claim 11 wherein said synchronous detector further comprises a low pass filter coupled between the output of the switch and the processor.

13. A method for orienting a tiltable mirror so that an optical beam reflected therefrom is directed to a selected receiver with a particular coupling efficiency, said method comprising the steps of:
varying an orientation of the mirror about a static position at a prescribed frequency;
receiving a signal representing an amount of optical energy incident on the selected receiver;
rectifying said received signal at said prescribed frequency to generate an error signal;
adjusting the static position of the mirror based on said error signal.

14. The method of claim 13 wherein said prescribed frequency is a fixed frequency.

15. The method of claim 13 wherein said prescribed frequency is a frequency with a psuedo-random sequence.

16. The method of claim 13 wherein said optical beam is a WDM optical signal.

17. The method of claim 15 wherein said optical beam is a WDM optical signal.

18. The method of claim 13 wherein the step of adjusting the static position of the mirror includes the step of adjusting the static position of the mirror to maximize the particular coupling efficiency.

19. The method of claim 13 wherein the step of varying the orientation of the mirror includes the step of generating a reference signal for dithering the mirror orientation about a static position at the prescribed frequency and the step of rectifying said received signal includes the step of driving at least one switch having inverting and noninverting inputs between each of said inputs at the prescribed frequency.

20. The method of claim 19 wherein said at least one switch comprises two switches driven in quadrature.

21. A method for orienting a tiltable mirror so that an optical beam reflected therefrom is directed to a selected receiver with a particular coupling efficiency, said method comprising the steps of:
varying an orientation of the mirror about a static position at a prescribed frequency;
receiving a synchronous signal synchronized to the prescribed frequency, said synchronous signal representing an amount of optical energy incident on the selected receiver;
adjusting the static position of the mirror based on said synchronous signal.

22. The method of claim 21 wherein said prescribed frequency is a fixed frequency.

23. The method of claim 21 wherein said prescribed frequency is a frequency with a psuedo-random sequence.

24. The method of claim 21 wherein said optical beam is a WDM optical signal.

25. The method of claim 23 wherein said optical beam is a WDM optical signal.

26. The method of claim 21 wherein the step of adjusting the static position of the mirror includes the step of adjusting the static position of the mirror to maximize the particular coupling efficiency of the optical beam between the mirror and the receiver.

27. The method of claim 21 wherein the step of varying the orientation of the mirror includes the step of generating a reference signal for dithering the mirror orientation about a static position at the prescribed frequency and the step of rectifying said received signal includes the step of driving at least one switch having inverting and noninverting inputs between each of said inputs at the prescribed frequency.

28. The method of claim 27 wherein said at least one switch comprises two switches driven in quadrature.

29. An optical switch, comprising:
an optical arrangement that includes:
a plurality of input/output ports for receiving one or more wavelength components from among a plurality of components of a WDM optical signal;
a plurality of wavelength selective elements each selecting a wavelength component from among the plurality of wavelength components;
a plurality of optical elements each associated with one of the wavelength selective elements, each of said optical elements directing the selected wavelength component selected by the associated selective element to a given one of the plurality of input/output ports independently of every other wavelength component, said given input/output port being variably selectable from among any of the plurality of input/output ports;
at least one receiver for receiving the selected wavelength components;
a plurality of controllers each associated with and driving one of the optical elements, each of said controllers including an alignment mechanism, responsive to a signal received from the receiver, for orienting the optical element so that the selected wavelength directed by the optical element is coupled to the receiver with a particular efficiency.

30. The optical switch of claim 29 further comprising a free space region disposed between the input/output ports and the wavelength selective elements.

31. The optical switch of claim 29 wherein said wavelength selective elements are thin film filters each transmitting therethrough a different one of the wavelength components and reflecting the remaining wavelength components.

32. The optical switch of claim 29 wherein said optical elements are reflective mirrors that are selectively tiltable in a plurality of positions such that in each of the positions the mirrors reflect the wavelength component incident thereon to any selected one of the input/output ports.

33. The optical switch of claim 32 wherein said reflective mirrors are part of a micro-electromechanical (MEM) reflective mirror assembly.

34. The optical switch of claim 30 wherein said free space region comprises an optically transparent substrate having first and second parallel surfaces, said plurality of wavelength selective elements being arranged in first and second arrays extending along the first and second parallel surfaces, respectively.

35. The optical switch of claim 34 wherein the optically transparent substrate includes air as a medium in which the optical signal propagates.

36. The optical switch of claim 35 where the optically transparent substrate is silica glass.

37. The optical switch of claim 34 wherein said first and second arrays are laterally offset with respect to one another.

38. The optical switch of claim 37 wherein each of said wavelength selective elements arranged in the first array direct the selected wavelength component to another of said wavelength selective elements arranged in the second array.

39. The optical switch of claim 29 further comprising a collimating lens disposed between each one of said wavelength selective elements and the optical element associated therewith, each of said optical elements being positioned at a focal point of the lens associated therewith.

40. The optical switch of claim 29 wherein said alignment mechanism includes a synchronous detector.

41. The optical switch of claim 29 wherein said alignment mechanism includes a two-phase lock-in amplifier.

42. The optical switch of claim 29 wherein said synchronous detector includes a modulator for generating a reference signal for dithering the orientation of the optical element about a static position.

43. The optical switch of claim 42 wherein said reference signal is a fixed frequency signal.

44. The optical switch of claim 42 wherein said reference signal has a frequency with a psuedo-random sequence.

45. The optical switch of claim 29 wherein said particular efficiency is a maximized coupling efficiency.

46. The optical switch of claim 40 wherein said synchronous detector comprises:
a switch having inverting and noninverting inputs each receiving a signal from the receiver; and
a modulator for generating a reference signal for dithering the orientation of the optical element about a static position and for driving said switch between the inverting and noninverting inputs.

47. The optical switch of claim 46 wherein said controller further includes a processor receiving a second signal from the switch.

48. The optical switch of claim 47 wherein said synchronous detector further comprises a low pass filter coupled between the output of the switch and the processor.

49. The optical switch of claim 1 wherein said particular coupling efficiency is a predetermined coupling efficiency.

50. The method of claim 13 wherein said particular coupling efficiency is a predetermined coupling efficiency.

51. The method of claim 21 wherein said particular coupling efficiency is a predetermined coupling efficiency.

52. The optical switch of claim 29 wherein said particular coupling efficiency is a predetermined coupling efficiency.

53. The optical switch of claim 1 wherein said receiver includes an optical fiber having a first end on which the optical beam is incident.
